(19) United States
(12) Patent Application Publication
(10) Pub. No.: US 2012/0236323 A1
(43) Pub. Date: Sep. 20, 2012

(54) Method for Determining the Optical Measurement Path Length in a Duct Gas Monitoring System

(75) Inventor: Fredrik Kuoppa, Molndal (SE)

(73) Assignee: Siemens Aktiengesellschaft, Muenchen (DE)

(21) Appl. No.: 13/513,405

(22) PCT Filed: Dec. 4, 2009
(86) PCT No.: PCT/EP2009/066452

§ 371 Date: Jun. 1, 2012

(51) Int. Cl. G01B 11/02

(52) U.S. Cl. 356/634

(57) ABSTRACT

Method for determining the optical measurement path length in a duct gas monitoring system in a duct gas monitoring system configured to measure the concentration of a gas component of the duct gas from its wavelength-specific absorption light, wherein light is sent from a light source through a first purging tube, a gas duct and a second purging tube to a measuring detector, the purging tubes open into the gas duct and are flushed with a purge gas which, after flushing, is discharged into the gas duct.

### CROSS-REFERENCE TO RELATED APPLICATIONS

This is a U.S. national stage of application No. PCT/EP2009/066452 filed 4 Dec. 2009.

### BACKGROUND OF THE INVENTION

1. Field of the Invention

The invention relates to a method for determining an optical measurement path length in a duct gas monitoring system configured to measure the concentration of a gas component of the duct gas from its wavelength-specific absorption by sending light from a light source through a first purging tube, a gas duct and a second purging tube to a measuring detector, where the first and second purging tubes open into the gas duct and are flushed with a purge gas which, after flushing, is discharged into the gas duct.

2. Description of the Related Art

In spectroscopic gas analysis, the concentration of a known gas component, or gas components, in a gas mixture (i.e., measuring gas) is determined from a measured wavelength-specific absorption of the gas component or a measured absorption spectrum of the measuring gas, respectively. For this purpose, the measuring gas is introduced in a measuring volume having a predetermined optical measurement path length, e.g., a sample cell or, in case of in-situ process measurements, a gas duct, such as a gas-leading pipe, furnace, funnel or stack. The light of a light source, e.g., an infrared lamp or a tunable diode laser, is transmitted through the measuring volume to a measuring detector, e.g., an opto-pneumatic or solid-state detector, for generating a measuring detector output dependent on the light absorption in the optical path of the measuring volume.

In duct gas monitoring systems, the light source (or, equivalently, the free end piece of an optical fiber connected to a remote light source) and the measuring detector are usually arranged in two measuring heads which are mounted at diametrically opposed locations to the wall of the gas duct through which the measuring gas (i.e., duct gas) flows. Each of the measuring heads has a longitudinal chamber (i.e., purging tube) which at one end opens into the gas duct and at the other end contains the respective active optical component (i.e., light source or measuring detector). To keep the measuring gas away from the active optical components, the chambers are flushed with a purge gas that does not contain the measured gas component. After flushing the chambers, the purge gas is discharged into the gas duct. An optical window may be arranged in the longitudinal chamber for separating a main chamber containing the respective active optical component from a prechamber which opens to the gas duct. In this case, the prechamber is and the main chamber may be flushed with the purge gas.

For determining the concentration of the gas component of interest in the measuring gas, the wavelength-specific absorption of the gas component and the optical measurement path length in the gas duct must be known. Normally, the optical measurement path length may be defined as the distance between the open ends of the purging tubes. However, as the purge gas is discharged into the gas duct, the actual optical measurement path length is difficult to estimate, especially if the measurement path is short and the flow of the purge gas is high. Furthermore, the measurement path length may vary over time due to varying process conditions, such as pressure, flow and turbulence or due to corrosion-induced wear at the open ends of the purging tubes.

### SUMMARY OF THE INVENTION

It is therefore an object of the invention to provide an improved estimate of the optical measurement path length, especially when process conditions vary.

This and other objects and advantages are achieved in accordance with the invention by a method in which, during the measurement of the concentration of the gas component, the purging tubes are momentarily filled up with the duct gas, and the optical measurement path length is calculated from the known path length between the light source and the measuring detector multiplied by the ratio of the light absorption is measured when the purging tubes are filled with the purge gas and the light absorption measured when the purging tubes are filled with the duct gas, where the light absorptions are obtained in temporally adjacent measurements.

If there are optical windows arranged in the purging tubes for separating a main chamber containing the respective active optical component from a prechamber which opens to the gas duct, the path length between the light source and the measuring detector should be understood as the window-to-window path length. This path length may be measured at installation of the duct gas monitoring system and can be assumed to be constant.

The measured absorption (or absorption amplitude) is to be understood as a variable comprising the absorption relevant factors, such as the gas specific absorption coefficient, the gas concentration and the optical path length. As the time interval between the measurements of the light absorptions when the purging tubes are filled with the purge gas and when they are filled with the duct gas is very short, the concentration of the gas component of interest will remain unchanged so that the ratio of the optical measurement path length to be estimated and the known path length between the light source and the measuring detector directly corresponds to the ratio of the measured light absorptions. Thus, the actual optical measurement path length can be calculated from the known path length between the light source and the measuring detector multiplied by the ratio of the measured light absorptions.

The accuracy and robustness of the estimation may be increased in that, in the determined ratio of the measured light absorptions, the value of the light absorption measured when the purging tubes are filled with the purge gas is obtained as a mean value from at least two measurements before and after filling the purging tubes with the duct gas.

For the same reason, the measurements when the purging tubes are filled with the purge gas and when they are filled with the duct gas may be repeated several times with their results being processed using statistical methods such as averaging. If, for example, excessively large variations are found in the measured light absorptions, the estimation of the actual optical measurement path length should be discontinued and scheduled for another time.

In order to momentarily fill up the purging tubes with the duct gas, the purge gas supply is switched off and duct gas may be drawn from the gas duct through the purging tubes in opposite purge direction. This method has the advantage that the temperature of the duct gas in the purging tubes is substantially the same as in the gas duct therebetween. At least, the temperature of the duct gas in the purging tubes can be mathematically modeled with an optimal level of accuracy because the temperature at the open ends of the purging tubes is known (for cases where the gas monitoring is sensitive for the temperature of the measured medium, the temperature of the process is always measured or known), and the temperature at the other ends can be easily measured. Thus, the value of the light absorption measured when the purging tubes, are filled with the duct gas may be corrected with a temperature profile in the purging tubes which temperature profile is obtained from the measured or known temperature in the gas duct and the temperature measured at locations where the duct gas leaves the purging tubes.

As an alternative to the above described method of momentarily filling the purging tubes with the duct gas, the purge gas supply is switched off and the purging tubes are flushed in the purge direction with a portion of the duct gas that is branched off from the gas duct. This alternative embodiment can be used when even short term exposure of the duct gas can decrease the performance of the optical parts, normally the windows, of the gas monitoring system (e.g., soiling or condensation) because it allows pretreatment of the branched-off duct gas (e.g., filtering or drying). Compared with the above described first purging method, this alternative embodiment lacks knowledge of the temperature of the duct gas in the purging tubes. This problem can be solved by tempering (e.g., typically heating) the branched-off duct gas to the temperature of the duct gas in the optical measurement path between the purging tubes, thus obtaining a flat temperature profile in the purging tubes.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will be now described, by way example, with reference to the accompanying drawings, in which:

FIG. 1 is a cross sectional view of a duct gas monitoring system in accordance with the invention;

FIG. 2 shows an alternative embodiment of the duct gas monitoring system; and

FIG. 3 is a flowchart of the method in accordance with an embodiment of the invention.

### DETAILED DESCRIPTION OF THE PREFERRED EMBODIMENTS

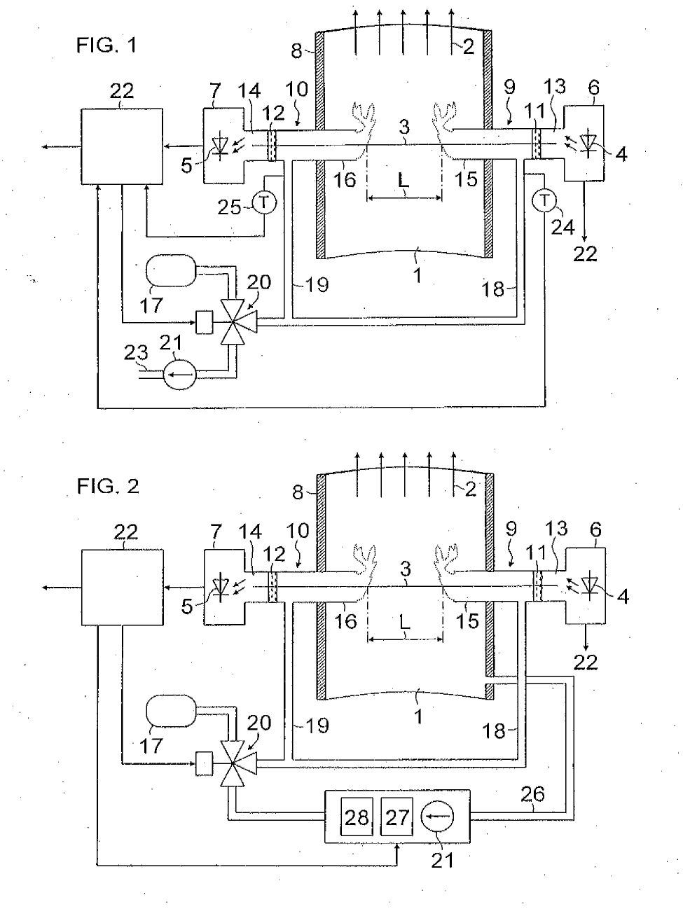

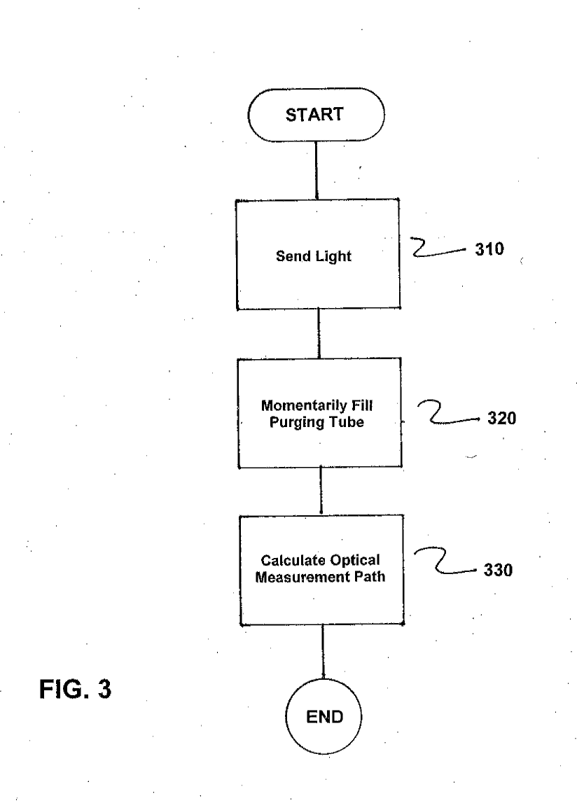

FIGS. 1 and 2 both show a gas duct 1 through which a duct gas 2 flows. The flow direction is indicated by the arrows. To measure the concentration of selected gas components, light 3 is sent from a light source 4 through the gas duct 1 to a measuring detector 5. The light source 4 may be a laser diode or the end piece of an optical fiber which carries the light of an external light source. The measuring detector 5 may be any conventional kind of photo detector.

The light source 4 and measuring detector 5 are arranged in respective different optical measuring heads 6 and 7 which are mounted at diametrically opposed locations to the wall 8 of the gas duct 1. Each of the measuring heads 6 and 7, which are largely identical in construction, has a longitudinal chamber 9, 10 which at one end opens into the gas duct 1 and at the other end contains the respective active optical component 4 or 5. In the illustrated example, the chambers 9, 10 each contain an optical window 11, 12 dividing the chamber 9, 10 into a main chamber 13, 14 containing the active optical component 4, 5 and a prechamber 15, 16 which is open to the gas duct 1. If necessary, the main chamber 13, 14 may each also contain a lens system.

The prechambers 15, 16 each serve as a purging tube and are flushed with a purge gas which does not contain the measured gas components. After flushing the prechambers or purging tubes 15, 16, the purge gas is discharged into the gas duct 1. The purge gas is provided by a purge gas source 17 from which gas lines 18, 19 lead to and discharge into the purging tubes 15, 16 at a points near the optical windows 11, 12. A controlled three-way valve 20 separates the gas lines 18, 19 from the purge gas source 17 and a gas pump or blower 21.

The three-way valve 20 as well the measuring detector 5 and the light source 4 are connected to a control and evaluation unit 22. The control and evaluation unit 22, which may be incorporated in the measuring head 7, evaluates the measuring detector 5 output to determine the concentration of the gas component to be measured from its wavelength-specific absorption. For this purpose, the optical measurement path length in the gas duct 1 must be known. It is evident from the FIGS. 1 and 2 that the optical measurement path length L cannot be simply defined as the distance between the open ends of the purging tubes 15, 16, especially if the measurement path is short and the flow of the purge gas is high. Furthermore, the measurement path length may vary over time due to varying process conditions. To determine the actual optical measurement path length L, the control and evaluation unit 22 controls the valve 20 to momentarily switch the gas lines 18, 19 from the purge gas source 17 to the gas pump or blower 21, so that the purging tubes 15, 16 will be momentarily filled with the duct gas 2.

In the example of FIG. 1, the gas pump or blower 21 is arranged to draw duct gas 2 from the gas duct 1 through the purging tubes 15, 16 into an exhaust line 23 which may discharge into the gas duct 1 at a point downstream of the purging tubes 15, 16. Temperature sensors 24 and 25 are provided and connected to the control and evaluation unit 22 to measure the temperature of the duct gas at locations at which the duct gas leaves the purging tubes 15, 16 and enters the gas lines 18, 19.

In the example of FIG. 2, the gas pump or blower 21 is arranged to draw, through a duct gas line 26, a portion of duct gas 2 from the gas duct 1 at a point upstream of the purging tubes 15, 16 and to transport the branched-off duct gas through the purging tubes 15, 16 back into the gas duct 1. A gas filter 27 and temperature control device 28 may be provided in the duct gas line 26 to retain particles, such as soot, from the duct gas 2 passing through it.

In the case of both FIG. 1 and FIG. 2, if the pressure drop in the gas duct 1 between the points where a portion of the duct gas is branched off and where it is fed back is sufficiently high, the gas pump or blower 21 may be omitted.

Propagating through the duct gas 2, the light 3 is attenuated exponentially according to the Beer-Lambert law:

I=I₀·exp(−c·α·L),

where I₀ is the intensity of the light emitted from the light source 4 at the wavelength of a molecular absorption line of the gas component of interest, I is the intensity of the light after passing through the measurement path having the length L and α is the absorption coefficient of the gas component of interest with the concentration c. The absorption coefficient α is temperature and pressure dependent. For small optical absorption, the above-given equation reduces to:

I=I₀·(l−c·α·L),

where A=c·α·L is the light absorption.

The steps for determining or calibrating the optical measurement path length L are as follows:

1. The purge tubes 15, 16 are flushed with the purge gas.

2. The light absorption Ai is measured.

3. The valve 20 is engaged or switched so that the purge gas is shut off and the purging tubes 15, 16 fill with the duct gas 2. A pause is initiated until the purging tubes 15, 16 are filled with the duct gas 2.

4. The light absorption A_{w-w} is measured.

5. The valve 20 is released or switched back so the purge gas flows into the purging tubes 15, 16. Another pause is initiated until the purging tubes 15, 16 are filled with the purge gas 2.

6. The light absorption A₂ is then measured.

7. As the light absorption values A₁, A_{w-w}, A₂ are obtained in quick succession, the concentration c of the gas component of interest will remain unchanged, so that A₁=c·α·L₁, A_{w-w}=c·α·L_{w-w} and A=c·α·L₂, where L₁ and L₂ are equal or at least similar and L_{w-w} is the known path length between the light source 4 and the measuring detector 5 (here, the window-to-window path length). The actual optical measurement path length L can therefore be calculated by

L=A₁/A_{w-w}·L_{w-w} or L=A₂/A_{w-w}·L_{w-w} or better

L=(A1+A2)/(2·A_{w-w})·L_{w-w}.

The measurement path length determination or calibration is complete and the concentration can be calculated using the updated actual measurement path length L.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A method for determining an optical measurement path length in a duct gas monitoring system configured to measure a concentration of a gas component of the duct gas from its wavelength-specific absorption, the method comprising:
sending light from a light source through a first purging tube, a gas duct and a second purging tube to a measuring detector, the first and second purging tubes opening into the gas duct and are flushed with a purge gas which, after flushing, is discharged into the gas duct;
momentarily, during the measuring of the concentration of the gas component, filling the purging tubes with the duct gas;
calculating an optical measurement path length from a known path length between the light source and the measuring detector multiplied by a ratio of the light absorption measured when the purging tubes are filled with the purge gas and the light absorption measured when the purging tubes are filled with the duct gas, the light absorptions being obtained in temporally adjacent measurements.

10. The method of claim 9, wherein, in the ratio of measured light absorptions, a value of the light absorption-measured when the purging tubes are filled with the purge gas is obtained as a mean value from at least two measurements before and after filling the purging tubes with the duct gas.

11. The method of claim 9, wherein the measurements when the purging tubes are filled with the purge gas and when they are filled with the duct gas are repeated several times with their results being processed using statistical methods.

12. The method of claim 10, wherein the measurements when the purging tubes are filled with the purge gas and when they are filled with the duct gas are repeated several times with their results being processed using statistical methods.

13. The method of claim 9, wherein said step of momentarily filling the purging tubes with the duct gas comprises:
switching off a purge gas supply and drawing the duct gas from the gas duct in an opposite purge direction.

14. The method of claim 13, further comprising:
correcting the value of the light absorption measured when the purging tubes are filled with the duct gas with a temperature profile in the purging tubes;
wherein the temperature profile is obtained from at least one of a measured and known temperature in the gas duct and a temperature measured at locations at which the duct gas exits the purging tubes.

15. The method of claim 9, wherein said step of momentarily filling the purging tubes with the duct gas comprises:
switching off the purge gas supply and flushing the purging tubes in a purge direction with a portion of the duct gas branched off from the gas duct.

16. The method of claim 10, wherein said step of momentarily filling the purging tubes with the duct gas comprises:
switching off the purge gas supply and flushing the purging tubes in a purge direction with a portion of the duct gas branched off from the gas duct.

17. The method of claim 11, wherein said step of momentarily filling the purging tubes with the duct gas comprises:
switching off the purge gas supply and flushing the purging tubes in a purge direction with a portion of the duct gas branched off from the gas duct.

18. The method of claim 15, wherein the branched-off duct gas is tempered to a temperature of the duct gas in the optical measurement path between the purging tubes.

19. A duct gas monitoring system configured to measure a concentration of a gas component of the duct gas from its wavelength-specific absorption to determine an optical measurement path length, comprising:
a first purging tube;
a second purging tube;
a gas duct;
a measuring detector;
a purge gas source;
a pump;
a duct gas line connected to the gas duct at a point upstream of the first and second purging tubes;
a light source, the light source and the measuring detector being arranged with respect to the gas duct such that light travels from the light source through the first purging tube, the gas duct and the second purging tube to the measuring detector, the first and second purging tubes opening into the gas duct and being connected to the purge gas source; and
a valve configured to control, during the measurement of the concentration of the gas component, one of momentary switching of the first and second purging tubes from the purge gas source to the pump to draw the duct gas from the gas duct in an opposite purge direction or momentary switching of the first and second purging tubes from the purge gas source to the duct gas line connected to the gas duct at the point upstream of the purging tubes.
